(19) United States
(12) Patent Application Publication
(10) Pub. No.: US 2023/0266656 A1
(43) Pub. Date: Aug. 24, 2023

(54) LENS, THREE-DIMENSIONAL IMAGING MODULE, AND THREE-DIMENSIONAL IMAGING APPARATUS

(71) Applicant: GUANGDONG LAUNCA MEDICAL DEVICE TECHN. CO., LTD., Dongguan (CN)

(72) Inventors: Jian LU, Dongguan (CN); Yao LIU, Dongguan (CN); Pan TANG, Dongguan (CN)

(73) Assignee: GUANGDONG LAUNCA MEDICAL DEVICE TECHN. CO., LTD., Dongguan (CN)

(21) Appl. No.: 18/010,260

(22) PCT Filed: Jun. 15, 2020
(86) PCT No.: PCT/CN2020/096059

§ 371 Date: Dec. 14, 2022

(51) Int. Cl. G03B 35/08; G03B 9/02; H04N 13/207; H04N 13/254

(52) U.S. Cl. CPC G03B 35/08; G03B 9/02; H04N 13/207; H04N 13/254; G03B 15/02

(57) ABSTRACT

A lens has an incidence axis, and comprises a lens element. The lens element comprises at least two sub-lenses. The sub-lenses are non-rotationally symmetric structures. Each of the sub-lenses comprises an effective light transmission portion. Any two effective light transmission portions of the lens element are rotationally symmetric relative to the incidence axis. The effective light transmission portions of the lens element allow an incident light beam to pass therethrough so as to present mutually separate formed images at an image side of the lens. The number of formed images is equal to the number of sub-lenses of the lens element.

### TECHNICAL FIELD

The present disclosure relates to the technical field of three-dimensional imaging technology, in particular to a lens, a three-dimensional imaging module, and a three-dimensional imaging apparatus.

### BACKGROUND

Conventional three-dimensional imaging is generally achieved by providing two or more lenses at different angles, and obtaining two-dimensional images of the same object being photographed from different angles, thereby obtaining three-dimensional data by comparing and analyzing the two-dimensional image information from different angles. However, this kind of conventional three-dimensional imaging apparatus requires multiple lenses to achieve three-dimensional measurement, so that the size of the structure configured to have the lenses mounted in is large, and there are great operational limitations when in use.

### SUMMARY

According to embodiments of the present disclosure, a lens, a three-dimensional imaging module, and a three-dimensional imaging apparatus are provided.

A lens has an incident axis, and comprises a lens element. The lens element comprises at least two sub-lenses. The sub-lenses are non-rotationally symmetric structures. Each of the sub-lenses comprises an effective light passing portion. Any two effective light passing portions of the lens element are rotationally symmetric relative to the incident axis. The effective light passing portions of the lens element allow an incident light beam to pass therethrough so as to form mutually separate imaging images on an image side of the lens. The number of the imaging images is the same as the number of the sub-lenses of the lens element.

A three-dimensional imaging module comprises an image sensor and the above mentioned lens. The image sensor 210 is arranged on the image side of the lens.

A three-dimensional imaging apparatus comprises the above mentioned three-dimensional imaging module.

The details of one or more embodiments of the present disclosure are proposed in the following drawings and descriptions below. The other features, purposes and advantages of the present disclosure will become obvious from the specification, drawings and claims.

### BRIEF DESCRIPTION OF THE DRAWINGS

For a better description and illustration of those embodiments and/or examples of the disclosure herein, one or more of the drawings may be referred to. The additional details or examples used to describe the drawings should not be considered as limiting the scope of any of the inventions disclosed, the embodiments and/or examples currently described, and the best mode of these inventions as currently understood.

FIG. 1 shows schematic diagrams of a lens in two views according to an embodiment of the present disclosure.

FIG. 2 shows a distribution diagram of the imaging images corresponding to the lens in FIG. 1.

FIG. 3 is a schematic diagram of a three-dimensional imaging module according to an embodiment of the present disclosure.

FIG. 4 is a schematic diagram of a three-dimensional imaging module according to another embodiment of the present disclosure.

FIG. 5 is a configuration diagram of the sub-lenses and the apertures in the lens according to an embodiment of the present disclosure.

FIG. 6 shows a distribution diagram of the imaging images corresponding to the lens in FIG. 5.

FIG. 7 is a configuration diagram of the sub-lenses and the apertures in the lens according to another embodiment of the present disclosure.

FIG. 8 shows a distribution diagram of the imaging images corresponding to the lens in FIG. 7.

FIG. 9 is a configuration diagram of the sub-lenses and the apertures in the lens according to another embodiment of the present disclosure.

FIG. 10 is a schematic diagram of the lens element of the lens according to another embodiment of the present disclosure.

FIG. 11 shows a distribution diagram of the imaging images corresponding to the lens in FIG. 10.

FIG. 12 is a schematic diagram of the lens element of the lens according to another embodiment of the present disclosure.

FIG. 13 is a schematic diagram of the lens element of the lens according to another embodiment of the present disclosure.

FIG. 14 shows a distribution diagram of the imaging images corresponding to the lens in FIG. 13.

FIG. 15 is a schematic diagram of a three-dimensional imaging module according to an embodiment of the present disclosure.

FIG. 16 is part of a schematic diagram of the three-dimensional imaging apparatus according to an embodiment of the present disclosure.

### DETAILED DESCRIPTION OF THE EMBODIMENTS

In order to facilitate the understanding of the present disclosure, the present disclosure will be described more comprehensively below with reference to the relevant accompanying drawings. Preferred implementations of the present disclosure are given in the accompanying drawings. However, the present disclosure may be implemented in many different manners and not limited to the implementations described herein. Rather, these embodiments are provided for the purpose of providing a more thorough and comprehensive understanding of the disclosure of the present disclosure.

It should be noted that when an element is described to be “fixed to” another element, it may be directly on the other element or there may also be an intermediate element. When an element is considered to be “connected” to another element, it may be directly connected to the other element or there can also be an intermediate element. The terms “in”, “out”, “left”, “right” and similar expressions used herein are for illustrative purposes only and are not meant to be the only means of implementation.

Conventional three-dimensional imaging is generally achieved by providing two or more lenses at different angles, and obtaining two-dimensional images of the same object being photographed at different angles, thereby obtaining three-dimensional data by comparing and analyzing the two-dimensional image information at different angles. However, the size of this kind of conventional three-dimensional imaging apparatus is large, and there are great operational limitations when in use.

Referring to FIG. 1, a lens 10 is provided according to some embodiments of the present disclosure. The lens 10 has a positive focal power, and is configured to converge image information of an object being photographed onto an imaging surface 103. The lens 10 includes a lens barrel 100 and a lens element 110 having a special-shaped structure. The lens element 110 is arranged in the lens barrel 100. An object end of the lens barrel 100 is provided with a light inlet aperture 1001. A central axis of the light inlet aperture 1001 is co-linear with an incident axis 101 of the lens 10, and the imaging surface 103 of the lens 10 is perpendicular to the incident axis 101. The imaging surface 103 may be the light-sensitive surface of the image sensor.

In these embodiments, the lens element 110 includes two mutually spaced sub-lenses in a direction perpendicular to the incident axis 101. The two sub-lenses are each has a non-rotationally symmetric structure. That is, there is no such a symmetry axis that, around this symmetry axis either sub-lens can be rotated by an angle of θ (<θ<360°) and still coincide with the sub-lens when it is not rotated. The two sub-lenses are centrally symmetric relative to the incident axis 101. The two sub-lenses which are central symmetric are structurally identical, e.g., the two sub-lenses have the same face shape on the object side and the same face shape on the image side. The shapes of the projections of the two sub-lenses on the imaging surface 103 in a direction parallel to the incident axis 101 are the same semicircle, and the two sub-lenses can be spliced into a complete lens by translation in a direction perpendicular to the incident axis 101. On the other hand, each sub-lens includes an arcuate edge 1107, and the arcuate edge of each sub-lens 1107 is away from the incident axis 101. When the two above sub-lenses in the semicircular shape are spliced into a complete lens, the arcuate edges 1107 of the two sub-lenses would serve as effective light passing edges of the object side or the image side of the lens.

Specifically, the two sub-lenses may be formed by equally cutting one complete lens. The cutting path passes through and is parallel to an optical axis of the lens. The cutting surfaces of the two sub-lenses formed by the cutting are flat and remain parallel to each other, and the cut two sub-lenses are spaced apart along a direction perpendicular to lens axis. The above-mentioned complete lens has positive focal power. The object side of the lens may be spherical or aspherical, and the image side thereof may be spherical or aspherical, so that the object side and the image side of each of the sub-lenses will have the corresponding surface shape when the lens is separated into two sub-lenses.

In an embodiment shown in FIG. 1, each sub-lens can form one imaging unit, and each imaging unit corresponds to one imaging image. An incident light beam, after being converged by the imaging units, can form imaging images on the imaging surface 103 of the lens 10, and the number of the imaging images is equal to the number of the imaging units. Each of the sub-lenses includes an effective light passing portion 1101. Both the object side and the image side of each sub-lens include an effective light passing portion 1101. Any two effective light passing portions 1101 of a same lens element 110 are rotationally symmetric relative to the incident axis 101. For the incident light beam allowed to pass through the sub-lens to form a corresponding imaging image on the image surface, the region of the sub-lens through which the incident light beam passes is the effective light passing portion 1101 of the sub-lens. In some embodiments, any two of the sub-lenses in the same lens element 110 are rotationally symmetric relative to the incident axis. In addition, in some embodiments, a rotation symmetry angle of two of the effective light passing portions 1101 in the same lens element 110 may be, but not limited to, 60°, 90°, 120°, 180°. Wherein, when the two of the effective light passing portions 1101 are rotationally symmetric at an angle of 180° relative to the incident axis 101, the two of the effective light passing portions 1101 are centrally symmetric relative to the incident axis 101.

The spacing arrangement of the above mentioned sub-lenses can make the imaging images on the imaging surface 103 spaced apart from each other, such that three-dimensional analysis of corresponding features in the two imaging images can be performed at a system terminal.

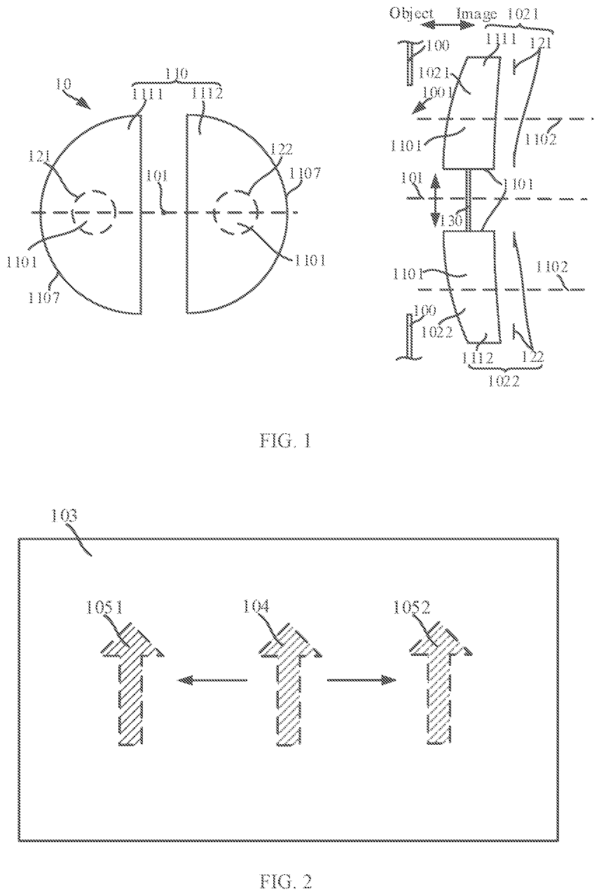

Referring to FIG. 2, when the lens element 110 in the lens 10 is a complete lens, the object being photographed, after being converged by the lens, can form one original imaging image 104 on the imaging surface 103 of the lens 10. When the lens element 110, as in the above-mentioned embodiments, is cut into two mutually spaced sub-lenses, the incident light beam, after passing through each of the sub-lenses, will respectively form a new imaging image on the imaging surface 103. The two new imaging images can reflect the imaging of a same region of the object being photographed from different angles. The original imaging image 104 on the imaging surface 103 will be gradually separated into two new imaging images as the spacing distance between the sub-lenses increases. Wherein, a distance that the two sub-lenses can be spliced into a complete lens after being translated by such distance is the spacing distance of the two sub-lenses. The separation direction of the imaging images partly depends on a direction in which the sub-lenses are moved away from the incident axis 101. For example, referring to a complete lens without being cut, when the lens is cut into two spaced sub-lenses in a direction relative to the incident axis 101, the imaging images corresponding to the two sub-lenses after being cut will also be separated in that direction. When the spacing distance between the sub-lenses is large enough, the two new imaging images will be completely separated from each other and will not overlap each other, and spacing will appear between the two new imaging images by this time. Subsequently, three-dimensional information such as the depths, heights or the like, of the corresponding features can be obtained after terminal analysis on features such as depressions and bumps etc. in the two spaced imaging images. Methods of the terminal analysis include but are not limited to a binocular vision ranging method or the like.

In designs of the above embodiments, it is only necessary to spacing the sub-lenses in the lens 10 by a distance in a direction perpendicular to the incident axis 101 to cause a spacing appear between the two new imaging images, so that imaging images of the object being photographed from different angles can be obtained by one lens 10. Compared with a common lens with a rotationally symmetric structure, the non-rotationally symmetric structure enables a reduction of a structural dimension of the sub-lenses in the radial direction, so that two or more sub-lenses can be accommodated in a single lens. And compared with a design of two or more lenses 10, the above-mentioned design of the single lens 10 can greatly reduce the lateral dimension of the three-dimensional imaging system and enable the three-dimensional imaging system to achieve a small size design, so that it is also conducive to reducing the dimension of the structure for installing the lens 10 in three-dimensional imaging apparatus, enabling the device to better perform three-dimensional imaging in narrow spaces. For example, when the lens 10 is installed in a probe of an endoscope, only one lens 10 is needed to obtain three-dimensional information, so that the dimensions of the probe can be effectively reduced, thereby improving the operational flexibility of the probe in narrow spaces.

Continuing to refer to FIG. 1, in some embodiments, the lens 10 includes apertures, which may be integrally formed with the lens barrel 100. The number of apertures is the equal to the number of the sub-lenses of the lens element 110, and the sub-lenses in a same lens element 110 are in a one-to-one correspondence with the apertures, wherein each sub-lens and aperture together form an imaging unit. An overlap exists between projections of each sub-lens and its corresponding aperture on the imaging surface 103 in a direction parallel to the incident axis 101. In addition, any two of the apertures are centrally symmetric relative to the incident axis 101 of the lens 10, and aperture diameters of the apertures are the same, so that the brightness of the imaging images formed by the imaging units tends to be the same, and the image size thereof also tends to be the same, thereby being conducive to the accuracy of the terminal analysis. In addition to being arranged in a centrally symmetric manner, any two apertures in some embodiments can also be arranged in other rotationally symmetric ways, and the specific arrangement thereof depends on how the sub-lenses of the lens element 110 are arranged. The aperture can also be configured to limit the edge light beam to suppress the spherical aberration caused by the edge light beam, and control the depth of field of the imaging image. In some other embodiments, the apertures are relatively independent of the lens barrel 100 and can be assembled together with the lens element 110 when the lens element 110 is installed into the lens barrel 100. In the embodiment shown in FIG. 1, the two sub-lenses are respectively a first sub-lens 1111 and a second sub-lens 1112, and the two apertures are respectively a first aperture 121 and a second aperture 122. The first aperture 121 is arranged on the image side of the first sub-lens 1111, and the second aperture 122 is arranged on the image side of the second sub-lens 1112. A line connecting the centers of the first aperture 121 and the second aperture 122 is perpendicular to the incident axis 101. In a direction parallel to the incident axis 101, an overlap exists between the projections of the first sub-lens 1111 and the first aperture 121 on the imaging surface 103, and an overlap exist between the projections of the second sub-lens 1112 and the second aperture 122 on the imaging surface 103.

With combined reference to FIG. 2, the first sub-lens 1111 and the first aperture 121 form the first imaging unit 1021, the second sub-lens 1112 and the second aperture 122 form the second imaging unit 1022. Correspondingly, the two separate imaging images are respectively the first imaging image 1051 and the second imaging image 1052, the first imaging unit 1021 corresponds to the first imaging image 1051 and the second imaging unit 1022 corresponds to the second imaging image 1052. The incident light beam enters the lens 10 through the light inlet aperture 1001 of the lens barrel 100, and form the first imaging image 1051 on the imaging surface 103 after being converged by the first imaging unit 1021 and form the second formed image 1052 on the imaging surface 103 after being converged by the second imaging unit 1022. For a feature structure of a depression or a bump on the object being photographed, the corresponding imaging of the depression and the bump on the imaging image will have different degrees of dispersion, and the first imaging unit 1021 and the second imaging unit 1022 spaced apart can image the feature structure from different angles, so that the lens 10 also can achieve the effect of binocular vision. By perform terminal analysis on the same feature on the first imaging image 1051 and the second imaging image 1052, such as the dispersion of feature imaging and/or the spacing distance between the feature imaging in the two imaging images, the depth information of the feature structure can be obtained. By utilizing the lens 10 of the above-mentioned embodiment, three-dimensional imaging information can be reconstructed based on the two-dimensional imaging information of the object being photographed, thereby realizing three-dimensional imaging of the object being photographed.

In some other embodiments, the first aperture 121 may be arranged on the object side of the first sub-lens 1111, and the second aperture 122 may also be arranged on the object side of the second sub-lens 1112, and the line connecting the centers of the first sub-lens 1111 and the second sub-lens 1112 remains perpendicular to the incident axis 101. The symmetric arrangements of the sub-lenses and the apertures relative to the incident axis 101 are conducive to improving the consistency of the brightness, sharpness, and size of the imaging images, thereby further being conducive to the accuracy of the terminal analysis.

Moreover, in order to prevent the incident light beam beyond the first sub-lens 1111 and the second sub-lens 1112 from reaching the image sensor, in some embodiments, the lens 10 further includes a light-shielding board 130, which is connected between the sub-lenses of the lens element 110 and is light tight. The light-shielding board 130 may be a metal plate or a plastic plate, and the light-shielding board 130 may be arranged perpendicular to the incident axis 101. The light-shielding board 130 may be provided with a black coating, so as to prevent the incident light beam from being reflected by the light-shielding board 130 to form stray light in the lens 10. By connecting each sub-lens, the light-shielding board 130 can also serve to improve the mounting stability between the sub-lenses.

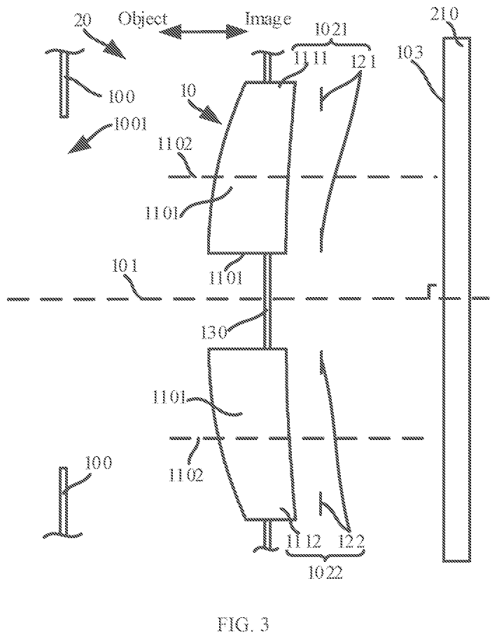

Referring to FIG. 3, a three-dimensional imaging module 20 is provided according to the embodiment in FIG. 3. The three-dimensional imaging module 20 includes an image sensor 210 and the lens 10 according to the above-mentioned embodiments. The image sensor 210 is arranged on the image side of the lens 10. The image sensor 210 may be a CCD (Charge Coupled Device) or a CMOS (Complementary Metal Oxide Semiconductor) element. The imaging surface 103 of the lens 10 overlaps the light-sensitive surface of the image sensor 210, and the incident axis 101 of the lens 10 is perpendicular to the light-sensitive surface and passes through a center of the light-sensitive surface. The light beam from the object being photographed, after being converged by the lens 10, can form two mutually spaced imaging images on the light-sensitive surface of the image sensor 210. In particular, when the number of the image sensors 210 is one, each of the imaging images can be presented on this one image sensor 210, so that the lateral size of the module can be effectively controlled, thereby further realizing a small size design of the three-dimensional imaging module 20.

The light-sensitive surface on the image sensor 210 generally has a shape of rectangle. In some embodiments, the spacing direction of the sub-lenses is parallel to a length direction of the light-sensitive surface, and a spacing distance between the sub-lenses, in the direction parallel to the length direction, is greater than or equal to half of the length of the light-sensitive surface, thereby facilitating the formation of two mutually spaced imaging images on the light-sensitive surface. The above spacing distance between the sub-lenses may be understood as the minimum distance between the two sub-lenses in the direction parallel to the length direction. Further, the spacing distance between the sub-lenses in the direction parallel to the length direction should be less than or equal to three-quarters of the length of the light-sensitive surface, thereby preventing the problem of degradation of imaging quality caused by a too large spacing distance between the sub-lenses.

In the above-mentioned embodiments, by using the above lens 10, the lateral size of the three-dimensional imaging module 20 can be effectively reduced, so as to expand the use space of the module, so that the three-dimensional imaging module 20 can achieve more efficient and flexible three-dimensional imaging in narrow spaces. It should be noted that, in addition to being provided with only one image sensor 210, three-dimensional imaging module 20 may also be provided with two or more image sensors 210, and each image sensor 210 corresponds to one or two imaging images.

Moreover, in order to avoid interference light from reaching the imaging surface 103, the three-dimensional imaging module 20 further includes a filter. The filter is arranged between the lens 10 and the image sensor 210, or it can also be arranged on the object side of the lens 10, such as be arranged covering the light inlet aperture 1001 of the lens barrel 100, and all of the above can be referred to as that the filter is arranged on the object side of the image sensor 210. For different wavelengths of working light, the filter may be a visible bandpass filter or an infrared bandpass filter. Generally, in a method of reconstructing a two-dimensional image into a three-dimensional image, there are corresponding analysis methods for imaging a range of wavelength bands or a specific wavelength band. When the three-dimensional imaging module 20 can perform three-dimensional reconstruction for visible imaging, the filter in the module may be an infrared cut-off filter, so that infrared light can be filtered out to prevent the infrared light from interfering with the visible imaging.

In some embodiments, the three-dimensional imaging module 20 includes a light source, and the light source is fixed relative to the lens 10. The light source is configured to irradiate the object being photographed, and the filter is configured to allow light at the wavelength emitted by the light source to pass therethrough. The lens 10 receives light irradiated by the light source to the object being photographed and reflected back, to form corresponding imaging images on the image sensor 210. Specifically, in an embodiment, when the three-dimensional imaging module 20 needs to perform imaging for a specific wavelength band (such as infrared light at 900 nm), the three-dimensional imaging module 20 may additionally be provided with an infrared light source to irradiate the object being photographed with infrared light at 900 nm, and in this case the filter can be selected as a narrow bandpass filter for 900 nm, so as to filter out the incident light beam other than the 900 nm wavelength. In some other embodiments, instead of the filter, a filter film may be arranged on the object side and/or the image side of the sub-lens to achieve the filtering effect. In addition to irradiating infrared light at this wavelength, the light sources in some embodiments may also irradiate infrared light at other wavelengths or monochromatic visible light.

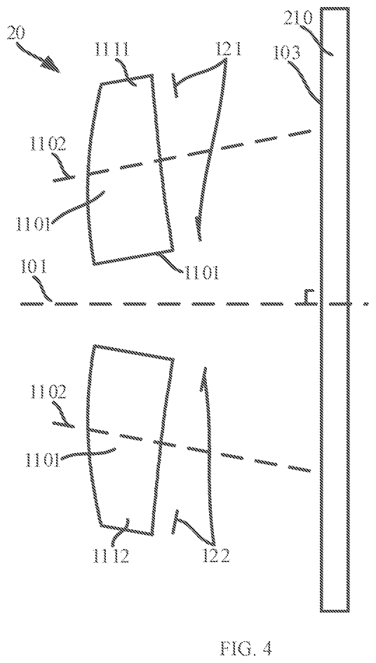

It should be noted that the configurations of each sub-lens and each aperture are not limited to the solutions mentioned in the above embodiments. Referring to FIG. 4, in some embodiments, an axial direction 1102 of each sub-lens is inclined to the incident axis 101. For each of the sub-lenses arranged inclined, the object side of each sub-lens is closer to the incident axis 101 than the image side of each sub-lens. When two sub-lenses are spliced into one lens, the axial direction 1102 of each sub-lens is parallel to the optical axis of the lens. In some embodiments, the angle between the axial direction 1102 of each sub-lens and the incident axis 101 of the lens 10 is in the range of 1° to 20°. The inclined arranged sub-lenses can enlarge the spacing distance between the imaging images, i.e., a spacing relationship between the corresponding imaging images can be formed by using a smaller spacing distance between the sub-lenses, thereby facilitating further reduction of the lateral size of the lens 10. In addition, by controlling the inclined angle, it also facilitates avoiding that the region where feature information exists on each imaging image is beyond the imaging range of the image sensor 210 due to a too large spacing distance between the imaging images. Similarly, each aperture corresponding to each sub-lens is arranged inclined in synchronization with the corresponding sub-lens, and the central axis of each aperture arranged inclined is parallel to the axial direction 1102 of the corresponding sub-lens, so as to enable the consistency of the brightness throughout the imaging image. The above inclined arrangement of each sub-lens and each aperture can be understood as that the corresponding imaging unit as a whole is arranged inclined. When the structures of the imaging units are the same or nearly the same, each imaging unit after being arranged inclined to the incident axis 101 should also be rotationally symmetric relative to the incident axis 101.

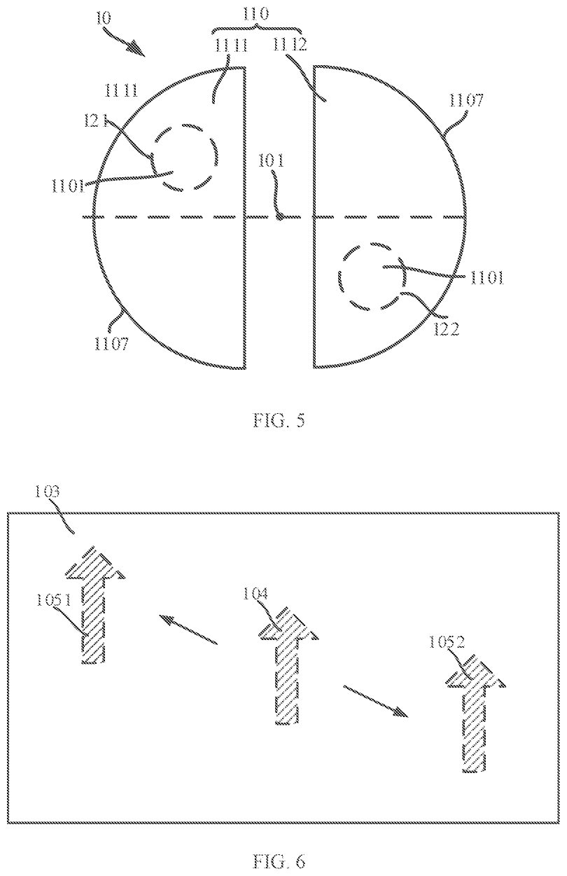

Moreover, the specific arrangement positions of the apertures may be variable and not limited to the arrangement solutions shown in FIG. 1. Comparing FIG. 1 with FIG. 5, in the embodiment shown in FIG. 1, the line connecting the centers of the two apertures is parallel to the spacing direction of the two sub-lenses, while in the embodiment shown in FIG. 5, the line connecting the centers of the two apertures is inclined to a line connecting the centers of gravity of the two sub-lenses. Depending on the positions of the apertures, the positions of the corresponding imaging images will change. Specifically, referring to FIGS. 5 and 6, FIG. 6 shows the arrangement of the imaging images corresponding to the lens 10 of the embodiment shown in FIG. 5, and the rectangular box in FIG. 6 shows the light-sensitive surface of the image sensor 210. The spacing direction of the sub-lenses is parallel to the length direction of the light-sensitive surface. When the line connecting the centers of the apertures is inclined to the spacing direction of the two sub-lenses, the two imaging images, after being separated in the length direction, will also be displaced in a direction inclined to the length direction. That is, the two imaging images will be spaced apart in a diagonal direction of the light-sensitive surface, thereby improving the utilization of the light-sensitive surface, increasing the imaging spacing of the same features of the object being photographed on the imaging surface 103, and facilitating improving the accuracy of the reconstructed three-dimensional information.

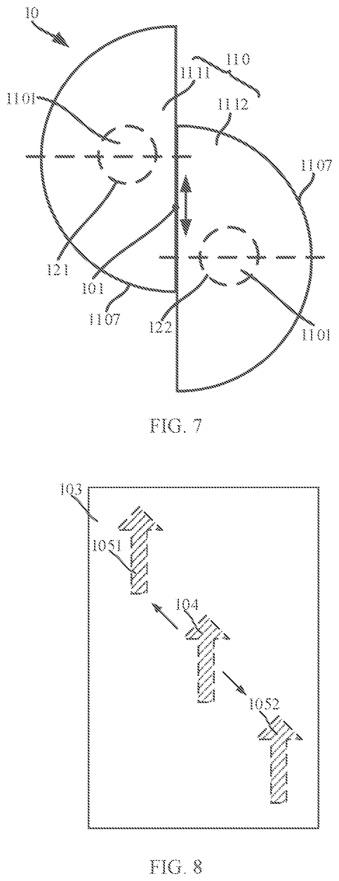

In addition to the spaced arrangement, the sub-lenses in the lens 10 element may be arranged in a staggered arrangement to obtain the spaced imaging images. Referring to FIG. 7, in some embodiments, the two sub-lenses that can be spliced into a complete lens are arranged in a staggered manner in a direction perpendicular to the incident axis 101. The two sub-lenses arranged in a staggered manner are abutted against each other. When the two sub-lenses are translated in a direction opposite to the staggering direction, the two sub-lenses can be spliced into a complete lens. Referring to FIG. 8 together, by the staggered arrangement, the separation distance between the two new imaging images will increase as the staggered distance between the two sub-lenses increases, and the separation direction of the two new imaging images partly depends on the staggering direction of the two sub-lenses. In the embodiment with the staggered arrangement, a distance that the two sub-lenses can be spliced into a complete lens after being translated by such distance is the staggered distance of the two sub-lenses.

In the embodiment according to the present disclosure, when the sub-lenses in the same lens element 110 are described as spaced or staggered, the sub-lenses can be described to be arranged separated, i.e., the separation arrangement does not mean that the corresponding sub-lenses must be arranged spaced, but can be arranged staggered in an abutment state. The separation direction of the sub-lenses refers to the spacing direction or staggering direction of the sub-lenses.

Moreover, the separation direction and separation distance of/between the two new imaging images also depends on the position relationship between the aperture and the sub-lens. In some embodiments, each of the sub-lenses is correspondingly arranged with an aperture to form an imaging unit, and the two apertures are spaced apart in a plane perpendicular to the incident axis 101. In these embodiments, a spacing distance exists between the apertures in the two imaging units in the direction perpendicular to the staggering direction and the incident axis 101, and the magnitude of the spacing distance will directly affect the separation distance of the two new imaging images in this direction. Therefore, due to the staggered distance existing between the first sub-lens 1111 and the second sub-lens 1112 in the staggering direction in the embodiment of FIG. 7, and the spacing distance existing between the first aperture 122 and the second aperture 122 in the direction perpendicular to the staggering direction, the finally two new imaging images on the imaging surface 103 each has a separation distance both in a direction parallel to the staggering direction and in a direction perpendicular to the staggering direction, thereby being presented separated along the diagonal as shown in FIG. 8.

In the embodiment shown in FIG. 7, in a direction parallel to the incident axis 101, there is an symmetry axis for the projections of the first aperture 121 and the first sub-lens 1111 on the imaging surface 103, and there is an symmetry axis for the projections of the second aperture 122 and the second sub-lens 1112 on the imaging surface 103. The two symmetry axes may be referred to the dotted lines in FIG. 7, and the two symmetry axes pass through the centers of the projections of the two apertures.

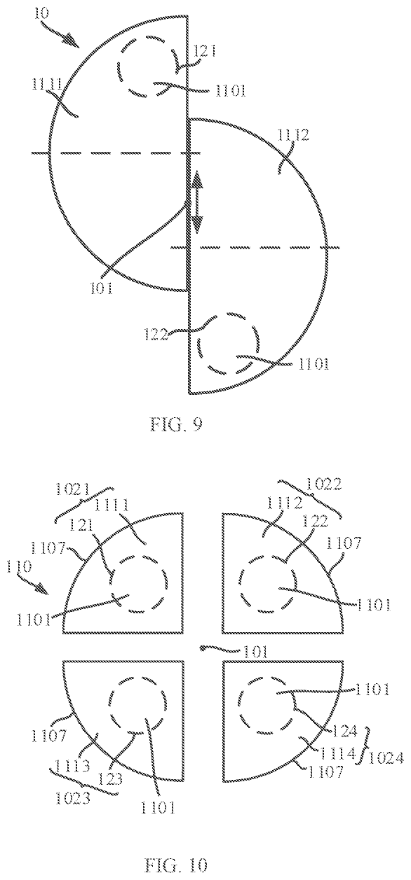

Referring to FIG. 9, in some other embodiments, the first aperture 121 and the second aperture 122 may also be arranged deviated from the corresponding symmetry axes described above. In the embodiment shown in FIG. 9, as the first aperture 121 and the second aperture 122 are further away from each other in the staggering direction, the separation distance between the corresponding first imaging image 1051 and second imaging image 1052 in the staggering direction will further increase. In these embodiments, the first aperture 121 and the second aperture 122 are rotationally symmetric relative to the incident axis 101, and the aperture diameters of the first aperture 121 and the second aperture 122 are the same.

By realizing the spaced and staggered design for the he sub-lenses in the lens element 110, and by adjusting the arrangement positions of the apertures, the imaging images with expected arrangement and separation relationship can be flexibly obtained. In addition, the arrangement relationships between the sub-lenses and between the apertures are not limited to the descriptions in the above embodiments, but any variations that can obtain the desired imaging images by the above arrangement principle shall be included in the scope of the present disclosure.

Further, in addition to the two shown in the above embodiment, the number of sub-lenses of the lens element 110 may be three, four or more. In this case, the sub-lenses are still arranged in a lens barrel. The sub-lenses may be formed by cutting one lens, and the cut sub-lenses are each a non-rotationally symmetric structure. Compared to multiple lenses each being a complete lens, the radial dimension of each sub-lens in the above design is smaller than that of the complete lens, so that the sub-lenses can be installed in one lens to reduce the lateral dimension of the module, and the incident light beam after passing through the above sub-lens can form mutually separate imaging images.

Specifically, referring to FIG. 10, in some embodiments, the lens element 110 includes four sub-lenses. In a direction parallel to the incident axis 101, the shapes of the projections of the four sub-lenses on the imaging surface 103 are fan-shaped. The four sub-lenses are spaced apart from each other, and surface shapes of the four sub-lenses are the same. In a direction parallel to the incident axis 101, the shapes of the projections of four sub-lenses on the imaging surface 103 are fan shaped. The four sub-lenses are rotationally symmetric relative to the incident axis 101 of the lens 10, and specifically may be centrally symmetric in some embodiments. As above, the four sub-lenses can be spliced into a complete lens when moved close to the incident axis 101. Specifically, the four sub-lenses may be formed by equally cutting the complete lens with the cutting paths passing through and being parallel to the central axis of the lens. The four sub-lenses are translated by a same distance in the radial direction of the original lens. The four sub-lenses, after being moved and being fixed by the lens barrel 100, belong to one lens element 110, and this lens element 110 is rotationally symmetric relative to the incident axis 101.

In the embodiment shown in FIG. 10, the lens 10 further includes four apertures, each of the apertures forms a corresponding relationship with one of the sub-lenses, and each group of a sub-lens and an aperture with the corresponding relationship constitute an imaging unit. That is, the lens 10 includes four imaging units, which are, respectively, a first imaging unit 1021, a second imaging unit 1022, a third imaging unit 1023, and a fourth imaging unit 1024. The first imaging unit 1021 includes a first sub-lens 1111 and a first aperture 121, the second imaging unit 1022 includes a second sub-lens 1112 and a second aperture 122, the third imaging unit 1023 includes a third sub-lens 1113 and a third aperture 123, and the fourth imaging unit 1024 includes a fourth sub-lens 1114 and a fourth aperture 124. The imaging units are spaced apart and symmetric relative to the incident axis 101, and an overlap exists between the projections of the sub-lens and the aperture on the imaging surface 103 in a same imaging unit. It can be seen from the above embodiment containing two sub-lenses that the spaced arrangement between the sub-lenses and between the apertures enable the corresponding imaging images to be separated from each other, and the separation direction and separation distance depend on the spacing direction and spacing distance between the sub-lenses, as well as on the arrangement positions of the apertures.

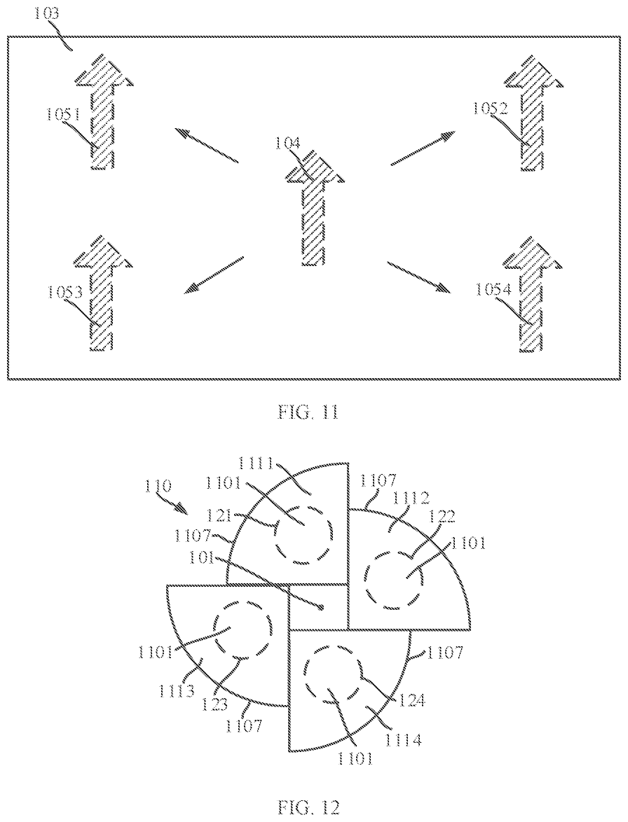

Referring to FIGS. 10 and 11, the light beam from the object being photographed within the depth of field of the lens 10 can form a clear first imaging image 1051 on the imaging surface 103 after being converged by the first imaging unit 1021, form a second imaging image 1052 on the imaging surface 103 after being converged by the second imaging unit 1022, form a third imaging image 1053 on the imaging surface 103 after being converged by the third imaging unit 1023, and form a fourth imaging image 1053 on the imaging surface 103 after being converged by the fourth imaging unit 1024. In the embodiment shown in FIG. 10, the four imaging units are symmetrically away from the incident axis 101 in a radial direction. Since the incident axis 101 passes through the center of the imaging surface 103, the four imaging images are also away from the center of the imaging surface 103 in corresponding directions of the imaging units away from the incident axis 101, thereby finally forming four separated imaging images.

Similarly, in addition to the spaced arrangement, the adjacent sub-lenses may also be arranged staggered to achieve separation of the imaging images, thereby forming four spaced imaging images.

Specifically, referring to FIG. 12, each of the four sub-lenses is staggered with other two of the sub-lenses, and the four sub-lenses are rotationally symmetric relative to the incident axis 101. When the lens element 110 has been rotated around the incident axis 101 by an angle of 90°, 135° or 180°, the structure remains the same and the formed imaging images remains unchanged. In the embodiment, the sub-lenses arranged staggered are abutted against each other, thus improving the stability of the lens element 110 in the lens barrel 100.

On the other hand, the lens element 110 can be a structure that is not rotationally symmetric relative to the incident axis 101, so as to increase the diversity of design of the lens 10.

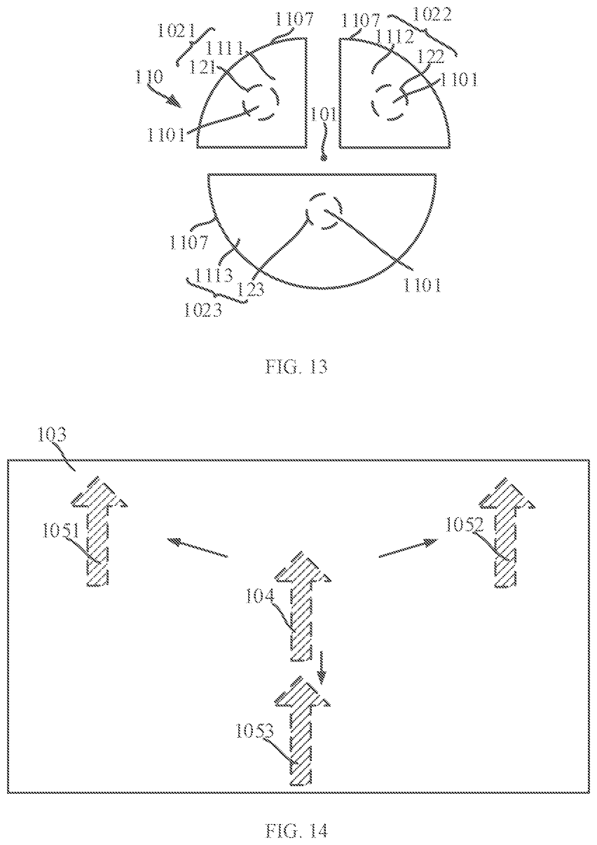

Referring to FIGS. 13 and 14, in some embodiments, the lens element 110 includes three sub-lenses, which are a first sub-lens 1111, a second sub-lens 1112, and a third sub-lens 1113, respectively. In a direction parallel to the incident axis 101, the shapes of the projections of the first sub-lens 1111 and the second sub-lens 1112 on the imaging surface 103 are the same fan shape, and the shape of the projection of the third sub-lens 1113 on the imaging surface 103 is a semicircle. Wherein, the area of the projections of the third sub-lens 1113 is the sum of the areas of the projections of the first sub-lens 1111 and the second sub-lens 1112. The first sub-lens 1111, the second sub-lens 1112, and the third sub-lens 1113 may be formed by cutting a complete lens, and the cutting paths may be referred to the dotted lines in FIG. 13. The cut three sub-lenses are translated by the same distance in the radial direction relative to the incident axis 101 to be fixed in the lens barrel 100, thereby forming a lens element 110. Accordingly, the lens 10 further includes three apertures, which are, respectively, a first aperture 121, a second aperture 122, and a third aperture 123. Specifically, in order to maintain the consistency of the depth of field and brightness of the images, in some embodiments, the aperture diameters of the first aperture 121, the second aperture 122, and the third aperture 123 are the same.

The first sub-lens 1111 and the first aperture 121 form a first imaging unit 1021, the second sub-lens 1112 and the second aperture 122 form a second imaging unit 1022, and the third sub-lens 1113 and the third aperture 123 form a third imaging unit 1023. Referring to FIG. 14, the light beam from the object being photographed within the depth of field of the lens 10 can form a clear first imaging image 1051 on the imaging surface 103 after being converged by the first imaging unit 1021, form a second imaging image 1052 on the imaging surface 103 after being converged by the second imaging unit 1022, and form a third imaging image 1053 on the imaging surface 103 after being converged by the third imaging unit 1023 on the imaging surface 103. Referring to FIG. 13, in comparison, when the lens 10 is provided with a conventional lens, and the optical axis of the conventional lens is co-linear with the incident axis 101 of the lens 10 and passes through the center of the imaging surface 103, the image formed by the incident light beam passing through the lens 10 is a single original imaging image 104 located in the center of the imaging surface 103 as shown in FIG. 14. In the embodiment shown in FIG. 13, the three imaging units are symmetrically away from the incident axis 101 in the radial direction. Since the incident axis 101 passes through the center of the imaging surface 103, the three imaging images are also away from the center of the imaging surface 103 in the corresponding directions, thereby finally forming three separated imaging images.

The above embodiments are mainly described around the case where the lens 10 is provided with one lens element 110. Further, in addition to being provided with one lens element 110, in some embodiments, the lens 10 may be provided with at least two lens elements 110, and the corresponding number of imaging images on the imaging surface 103 can be obtained. The number of lens elements 110 in the lens 10 may be two, three, four, five, or more, and the lens elements 110 are arranged in order along the direction of the incident axis 101. In these embodiments, the lens 10 still includes a lens barrel 100, and the lens elements 110 are disposed in the lens barrel 100. The sub-lenses of the lens elements 110 may be formed by cutting different lenses. For a lens 10 having two or more lens elements 110, the structure of the lens 10 may be considered to be formed by equally cutting a lens group that can be practically applied in the product. The lens group includes, but is not limited to, a telephoto lens group, a wide-angle lens group, a macro lens group, or the like.

In an embodiment of the present disclosure, the number of the imaging images of each lens element 110 is the same. Each of the sub-lenses of a lens element 110 forms a corresponding relationship with one of the sub-lenses of each of the other lens elements 110, and each group of sub-lenses with the corresponding relationship forms an imaging unit. in a direction parallel to the incident axis 101, an overlap exists between projections of the sub-lenses in a same imaging unit on the imaging surface 103. In particular, in some embodiments, any two adjacent sub-lenses in any imaging unit can be spaced apart from each other, or form a glued structure.

It should be noted that, in some embodiments, each sub-lens at least in one lens element 110 is coated with a light-shielding film, which is arranged on the object side and the image side of the sub-lens. A light passing region is retained on both the object side and image side of the sub-lens, and the areas of the object side and the image side of the sub-lens corresponding to the light passing region is the effective light passing portion 1101 of the corresponding sub-lens. In this case, the size of the effective light passing portion 1101 can affect the brightness and depth of field of the imaging image, and the distance between the effective light passing portions 1101 on different sub-lenses can also affect the separation of the imaging images.

In some other embodiments, apertures may also be arranged in the lens 10 to achieve the above effect. In this case, the number of the apertures is the same as the number of the sub-lenses of the lens element 110 and they are in a one-to-one correspondence with each other. In these embodiments, each imaging unit includes one aperture. in a direction parallel to the incident axis 101, an overlap exists between projections of the sub-lenses and the aperture in a same imaging unit on the imaging surface 103.

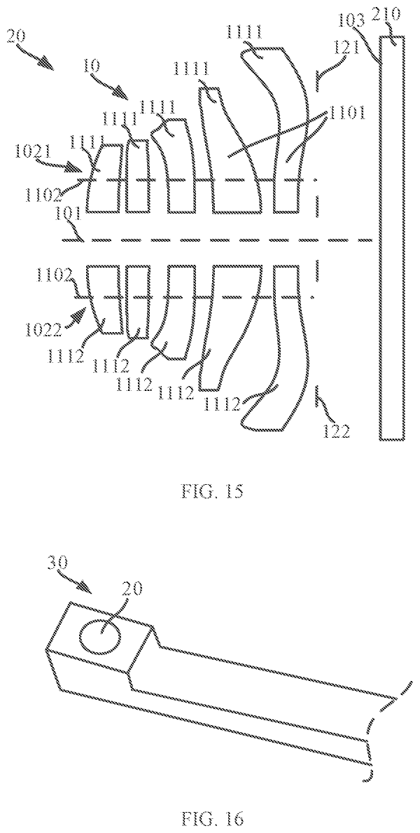

Specifically, referring to FIG. 15, in an embodiment of the present disclosure, the lens 10 includes five lens elements 110. Each lens element 110 includes two sub-lenses, which are a first sub-lens 1111 and a second sub-lens 1112, respectively. The first sub-lens 1111 and the second sub-lens 1112 are formed by equally cutting a complete lens. The shapes of the sub-lenses and the separation directions relative to the incident axis 101 may be referred to the embodiment shown in FIG. 1. In this embodiment, the first sub-lens 1111 and the second sub-lens 1112 in any one lens element 110 can be spliced into a complete lens after translating in a direction perpendicular to the incident axis 101. The lens 10 further includes a first aperture 121 and a second aperture 122. The first aperture 121 corresponds to each of the first sub-lenses 1111, and the second aperture 122 corresponds to each of the second sub-lenses 1112. In the direction parallel to the incident axis 101, an overlap exists between the projections of the first sub-lenses 11111 and the first aperture 121 on the imaging surface 103, and an overlap exists between the projections of the second sub-lenses 1112 and the second aperture 122 on the imaging surface 103. The first aperture 121 and the five first sub-lenses 1111 together form the first imaging unit 1021, and the second aperture 122 and the five second sub-lenses 1112 together form the second imaging unit 1022. The first aperture 121 may be arranged between the first sub-lens 1111 closest to the image side and the image sensor 210, or the first aperture 121 may also be arranged between any two of the first sub-lenses 1111, or be arranged on the object side of the first sub-lens 1111 farthest from the image sensor 210, and the second aperture 122 is arranged in a similar manner. It should be noted that in these embodiments, the first imaging unit 1021 and the second imaging unit 1022 are centrally symmetric relative to the incident axis 101, so as to ensure that the brightness, depth of field, and size of the corresponding imaging images tend to be the same.

In the embodiment shown in FIG. 15, a five-piece lens group as a whole may be cut along a radial direction into two equal semicircular sub-lens groups, and each of the semicircular sub-lens groups may form an imaging unit. The five-piece lens group may be a macro lens group, thereby facilitating obtaining excellent imaging in the case of short shooting distance, especially improving the sharpness of imaging in narrow spaces (such as the oral cavity, intestine, etc.), and further facilitating the accuracy of 3D reconstruction in the case of short shooting distances.

Referring to the FIG. 2 together, the incident light beam form the first imaging image 1051 on the imaging surface 103 after being converged by the first imaging unit 1021, and form the second imaging image 1052 on the imaging surface 103 after being converged by the second imaging unit 1022. The spacing direction between the first imaging image 1051 and the second imaging image 1052 depends on the spacing direction between the first imaging unit 1021 and the second imaging unit 1022, and also depends on the arrangement positions of the first aperture 121 and the second aperture 122. The spacing distance between the first imaging image 1051 and the second imaging image 1052 depends on the spacing distance between the first imaging unit 1021 and the second imaging unit 1022, and also depends on the arrangement positions of the first aperture 121 and the second aperture 122.

Moreover, in some embodiments, referring to the embodiment shown in FIG. 5 together, the first imaging unit 1021 and the second imaging unit 1022 may also be arranged inclined to the incident axis 101, i.e., the axes 1102 of the first imaging unit 1021 and the second imaging unit 1022 are inclined to the incident axis 101. In this case, a sub-lens on the object side is closer to the incident axis 101 than a sub-lens on the image side in the imaging unit.

Similarly, instead of being arranged spaced apart, the first sub-lens 1111 and the second sub-lens 1112 may be arranged staggered, such as in the embodiment shown in FIG. 7. The first sub-lens 1111 and the second sub-lens 1112 in each lens element 110 shall be moved in the same direction and by the same distance to form a staggered arrangement, and each first sub-lens 1111 and second sub-lens 1112 arranged staggered are abutted against each other. The imaging images can be further separated by adjusting the positions of the apertures. The arrangements of the apertures can be referred to the embodiments shown in FIGS. 7 and 9.

Moreover, each lens element 110, instead of including two sub-lenses, may also include three, four or more sub-lenses per lens element 110 as in the embodiment shown in FIG. 10 or 13. But it should be ensured that the number of sub-lenses in each lens element 110 is the same, each of the sub-lenses in any lens element 110 forms a corresponding relationship with one of the sub-lenses in each of the other lens elements 110, each group of sub-lenses having the corresponding relationship forms an imaging unit, and the number of the separated imaging images is equal to the number of the imaging units.

In the above embodiments, the sub-lenses in a same lens element 110 can be formed by cutting one single lens.

In some other embodiments, each of the sub-lenses may be prepared separately, but it should be ensured, as much as possible, that in the case of being installed in the lens barrel 100, the sub-lenses in a same lens element 110 shall be rotationally symmetric relative to the incident axis 101 of the lens 10, and that for the surface regions having a rotationally symmetric relationship in the sub-lenses, the centers of curvature the corresponding surface regions in the sub-lens has the same rotationally symmetric relationship relative to the incident axis 101. Specifically, in an embodiment, the lens element 110 includes the first sub-lens 1111 and the second sub-lens 1112. The first sub-lens 1111 and the second sub-lens 1112 are centrally symmetric relative to the incident axis 101, and in this case, the same spatial distribution structure may be obtained every time when the lens element 110 has been rotated by an angle of 180° relative to the incident axis 101.

In some embodiments, the number of the sub-lenses is not limited to two. The overall structure of any two of the sub-lenses is not limited to the case of central symmetry relative to the incident axis 101, but may also be any rotationally symmetric relationship or no symmetric relationship. However, it should be ensured, as much as possible, that any two effective light passing portions 1101 in a same lens element 110 have a rotationally symmetric relationship relative to the incident axis 101, so as to ensure that the sharpness of the imaging images corresponding to the sub-lenses tends to be the same, thereby improving the accuracy of the terminal analysis.

Referring to FIG. 16, an embodiment of the present disclosure further provides a three-dimensional imaging apparatus 30. The three-dimensional imaging apparatus 30 may include a three-dimensional imaging module 20 in any above embodiment. The three-dimensional imaging apparatus 30 may be applied in fields such as medical, industrial manufacturing or the like. Specifically, the three-dimensional imaging apparatus 30 may be, but not limited to, a smartphone, a tablet computer, a dental camera device, an industrial inspection device, an unmanned aerial vehicle, an in-vehicle camera device, or the like. Due to the smaller lateral dimension of the above three-dimensional imaging module 20 being used, the three-dimensional imaging apparatus can achieve a more efficient and flexible three-dimensional inspecting in narrow spaces. For example, when the three-dimensional imaging module 20 are arranged in the probe of the device, the small size feature of the module may make the size of the probe smaller, thereby improving the operational flexibility of the probe in narrow spaces.

In the description of the present disclosure, it is should to be understood that the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, “axial”, “radial”, “circumferential” etc. indicate the orientation or position relationship based on the orientation or position relationship shown in the accompanying drawings, only to facilitate and simplify the description of the present disclosure, and not to indicate or imply that the device or element referred to must have a specific orientation, and/or must be constructed and operated in a specific orientation, therefore it cannot be interpreted as a limitation of the present disclosure.

Furthermore, the terms “first” and “second” are used for descriptive purposes only and are not to be construed as indicating or implying relative importance or implicitly specifying the number of technical features indicated. Thus, the features qualified with “first” and “second” may explicitly or implicitly include at least one such feature. In the description of the present disclosure, the meaning of “plurality” means at least two, such as two, three, etc., unless there is an explicit and specific definition.

In the present disclosure, unless there is an explicit and specific definition, the terms “mounted”, “attached”, “connected”, “fixed”, etc. should be used in a broad sense. For example, it may be a fixed connection, a detachable connection, or in one piece, it may be a mechanical connection or an electrical connection, it may be a direct connection or an indirect connection through an intermediate medium; and it may be a connection within two components or an interactive relationship between two components. To those ordinary skilled in the art, the specific meaning of the above terms in the present disclosure can be understood according to the specific situation.

In the present disclosure, unless there is an explicit and specific definition, the first feature being “on” or “under” the second feature may refer to that the first feature and the second feature are in direct contact, or that the first feature and the second feature are in indirect contact through an intermediary. Moreover, the first feature being “above”, “over” and “on” the second feature may refer to that the first feature is directly above or diagonally above the second feature, or indicate that the horizontal height of the first feature is greater than that of the second feature. The first feature being “below”, “under” and “beneath” the second feature may refer to that the first feature is directly below or diagonally below the second feature, or indicate that the horizontal height of the first feature is smaller than that of the second feature.

In the description of the specification, the description of the reference terms “an embodiment”, “some embodiments”, “example”, “specific examples,” or “some examples” or the like, refers to that the specific features, structures, materials, or characteristics described in combination with the embodiment or the example are included in at least one embodiment or example according to the present disclosure. In the specification, the schematic description of the above terms does not have to be directed to the same embodiment or example. Further, the specific features, structures, materials, or characteristics described may be combined in any one or more embodiments or examples in a suitable manner. Moreover, without contradictions, a person skilled in the art may combine the different embodiments or examples, and the features in the different embodiments or examples described in the specification.

The technical features of the above mentioned embodiments can be arbitrarily combined. For the sake of concise description, all possible combinations of the technical features of the above mentioned embodiments are not described. However, it should be considered as the scope of this specification, as long as there is no contradiction in the combination of these technical features.

The above mentioned embodiments express only several implementations of the present disclosure, and the descriptions are more specific and detailed, but they should not be interpreted as a limitation of the scope of the present disclosure. It should be pointed out that for a person of ordinary technical personnel in the art, under the premise of not being separated from the practical new ideas, the number of deformations and improvements can be made, which all belong to the scope of protection of the present disclosure. Therefore, the scope of protection of the present disclosure shall be object being photographed to the attached claims.

1. A lens having an incident axis and comprising a lens element, the lens element comprising:
at least two sub-lenses, each of the sub-lenses having a non-rotationally symmetric structure, and each of the sub-lenses including:
an effective light passing portion, any two of the effective light passing portions of the lens element being rotationally symmetric relative to the incident axis,
wherein the at least two sub-lenses are capable of being spliced into a complete lens; and
wherein the effective light passing portions of the lens element are capable of allowing an incident light beam to pass therethrough so as to form mutually separate imaging images on an image side of the lens, and the number of the imaging images is the same as the number of the sub-lenses of the lens element.

2. The lens of claim 1, wherein the at least two sub-lenses are formed by cutting one complete lens.

3. The lens of claim 1, further comprising a plurality of lens elements, the plurality of lens elements being divided into at least two imaging units, wherein each of the imaging units includes a plurality of sub-lenses arranged in a direction parallel to the incident axis, and each of the sub-lenses of each of the imaging units is comprised in one of the lens elements.

4. The lens of claim 1, wherein the sub-lenses of a same lens element are arranged spaced apart or staggered in a direction perpendicular to the incident axis.

5. The lens of claim 1, wherein the lens meets any one of the following options:
the lens element includes two sub-lenses in a direction parallel to the incident axis, shapes of projections of the two sub-lenses on a plane perpendicular to the incident axis are semicircular;
the lens element includes three sub-lenses in a direction parallel to the incident axis, shapes of projections of two of the sub-lenses on a plane perpendicular to the incident axis are fan shaped, and a shape of a projection of the other one of the sub-lenses on the plane perpendicular to the incident axis is semicircular; and
the lens element includes four sub-lenses in a direction parallel to the incident axis, shapes of projections of the four sub-lenses on a plane perpendicular to the incident axis are fan shaped.

6. The lens of claim 1, wherein any two of the sub-lenses of the lens element are rotationally symmetric relative to the incident axis.

7. The lens of claim 1, further comprising at least two apertures, wherein the number of the apertures is equal to the number of the sub-lenses of the lens element, in a direction parallel to the incident axis, a projection of each of the sub-lenses and a projection of one of the apertures on a plane perpendicular to the incident axis overlap.

8. The lens of claim 7, wherein any two of the apertures are rotationally symmetric relative to the incident axis.

9. The lens of claim 8, wherein the number of the apertures and the number of the sub-lenses of the lens element are both two, and a line connecting centers of the two apertures is inclined to a line connecting centers of gravity of the two sub-lenses.

10. The lens of claim 7, wherein aperture diameters of the apertures are the same.

11. The lens of claim 1, further comprising a lens barrel, wherein the lens element is arranged in the lens barrel, an object end of the lens element is defined with a light inlet aperture, and a central axis of the light inlet aperture is coaxial with the incident axis of the lens.

12. The lens of claim 1, wherein two of the effective light passing portions of the lens element are centrally symmetric relative to the incident axis.

13. A three-dimensional imaging module, comprising:
one or more image sensor; and
a lens of claim 1, wherein the one or more image sensors are arranged on the image side of the lens.

14. The three-dimensional imaging module of claim 13, wherein the number of the one or more image sensors is one.

15. The three-dimensional imaging module of claim 13, further comprising a light source, wherein the light source is fixed relative to the lens, and the light source is configured to irradiate an object being photographed.

16. The lens of claim 15, wherein the light source is an infrared light source capable of irradiating infrared light.

17. The three-dimensional imaging module of claim 15, further comprising a filter, wherein the filter is arranged on an object side of the image sensor, and the filter is configured to allow light at a wavelength emitted by the light source to pass therethrough.

18. A three-dimensional imaging apparatus, comprising the three-dimensional imaging module of claim 12.

19. The lens of claim 2, wherein one cutting path or at least one of cutting paths passes through and is parallel to an optical axis or central axis of the complete lens.

20. The lens of claim 1, wherein a shape of a projection of the complete lens on a plane perpendicular to the incident axis is circular.
